(19) United States
(12) Patent Application Publication
(10) Pub. No.: US 2012/0073224 A1
(43) Pub. Date: Mar. 29, 2012

(54) COMPOSITE CLADDING

(75) Inventor: James Carolan, Kingscourt (IE)

(73) Assignee: Kingspan Research and Developments Limited.

(21) Appl. No.: 13/083,959

(22) Filed: Apr. 11, 2011

Related U.S. Application Data
(63) Continuation of application No. 11/792,820, filed on Jun. 12, 2007, now abandoned.

(30) Foreign Application Priority Data
Dec. 14, 2004 (IE) 2004/0836

(51) Int. Cl. E04C 2/284; B32B 37/14; B32B 37/12; E04C 2/20; B32B 37/02

(52) U.S. Cl. 52/309.4; 52/506.05; 156/78

(57) ABSTRACT

The panel 1 comprising a backing tray 2 and an external skin 3 with a layer of foam insulation material 4 therebetween. The external skin 3 has a plurality of mountings for fixing cladding elements such as tiles 5 to the panel to form a cladding. The mountings comprise rails 10 and fasteners 12 for fastening the rails 10 to the external skin 3. Each fastener 12 comprises an internal clamping sleeve 15 and a bolt 16. A hole is first drilled through the skin 3 and the sleeve 15 is inserted. On tightening of the bolt 16, the sleeve splays and is clamped against the inside surface of the external skin 3. To enhance the peel strength of the composite panel a layer 30 of an adhesive is applied to the internal face of the external skin 3.

### INTRODUCTION

The invention relates to a composite cladding panel of the type comprising an inner skin and an external skin with insulation foam material therebetween.

Buildings comprising a steel frame on which pre-formed panels are mounted may be erected quickly and more cheaply than buildings with brick or block facades.

One of the problems with buildings constructed from pre-formed panels is that such panels can often be uninteresting aesthetically. It is known to form such panels with various profiles and in various colours, however, there is still a need to provide an aesthetically different façade in some cases.

This invention is directed towards providing a panel system which will address this need.

### STATEMENTS OF INVENTION

According to the invention there is provided a composite cladding panel comprising an internal skin and an external skin with insulation material therebetween, one of the skins having a plurality of mountings for fixing tiles or the like to the panel to form a cladding.

In one embodiment the mountings comprise a rail and a plurality of fasteners for fastening the rail to the panel. The fastener may comprise a clamping fastener.

In one case the clamping fastener comprises an internal sleeve and a bolt, the sleeve clamping to the inside of the external skin on tightening of the bolt.

In one embodiment the rail comprises receivers for receiving cladding elements such as bricks.

In one embodiment the external skin has an adhesive on the inner face thereof, The adhesive may be applied to the inner face of the external skin prior to lay-down of liquid insulating foam reactants.

The invention also provides a method for manufacturing a composite cladding panel comprising the steps of:
manufacturing a composite insulating panel comprising an internal skin, an external skin with insulation material therebetween;

aligning mounting rails along at least portion of the external face of a skin; and
fastening the rails to the skin.

In one embodiment the method comprises the steps of drilling holes in the skin, inserting internal sleeves into the holes, and tightening bolts in the sleeves to clamp to the inside of the skin. The rail may be fixed to the panel using the bolts.

In one case the method comprises the steps of laying the external skin down with the outer side lowermost, applying an adhesive to the inner face of the external skin, applying liquid foam reactants over the adhesive, applying an internal skin over the liquid form reactants and heating the sandwich thus formed in an oven to form the composite insulating panel.

The invention further provides composite cladding panels when manufactured by a method of the invention.

### BRIEF DESCRIPTION OF THE DRAWINGS

The invention will be more clearly understood from the following description thereof given by way of example only, in which:

FIG. 1 is a cross-sectional view of a composite insulating cladding panel according to the invention;

FIG. 2 is cross-sectional view of the composite panel of FIG. 1 with no tiles in place;

FIGS. 3 and 4 are cross-sectional views illustrating a fastener used with the panel;

FIG. 5 is a perspective view of the fastener, in use;

FIG. 6 is an elevational view illustrating the panel with rails in place; and

FIG. 7 is an elevational view of the panel with some cladding tiles such as bricks in place.

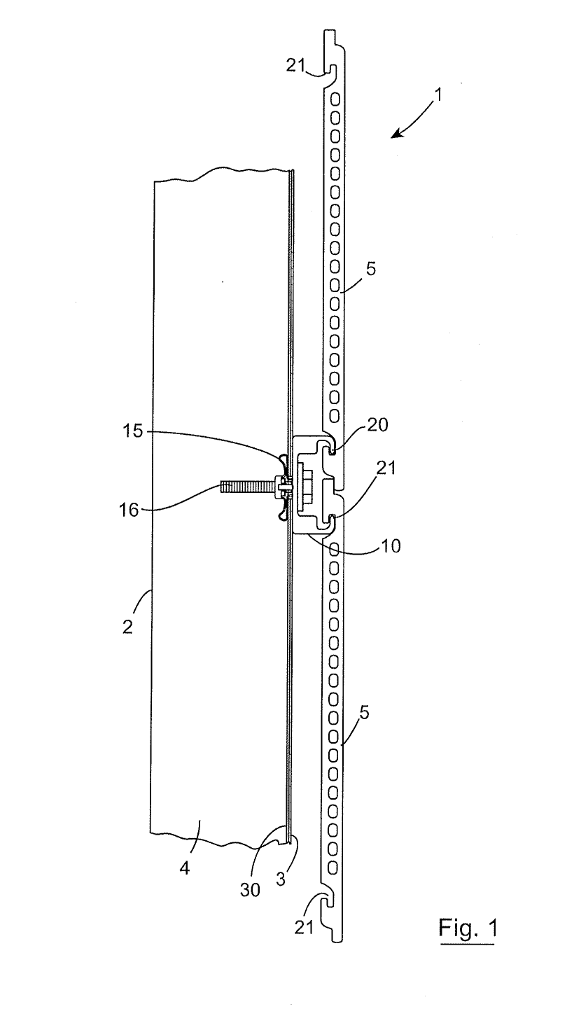

### DETAILED DESCRIPTION

Referring to the drawings there is illustrated a composite cladding panel 1 according to the invention. The panel 1 comprises a steel skin or backing tray 2 and an external steel skin 3 with a layer of foam insulation material 4 such as a phenolic or polyurethane based foam material therebetween. The panel may be of any suitable type such as that described in our UK2325678A, the entire contents of which are hereby incorporated by reference.

One of the skins, in this case the external skin 3 has a plurality of mountings for fixing façade or cladding elements such as tiles 5 to the panel. The tiles may be brick, ceramic or the like to form a cladding for the panel. The mountings comprise rails 10 and fasteners 12 for fastening the rails 10 to the external skin 3.

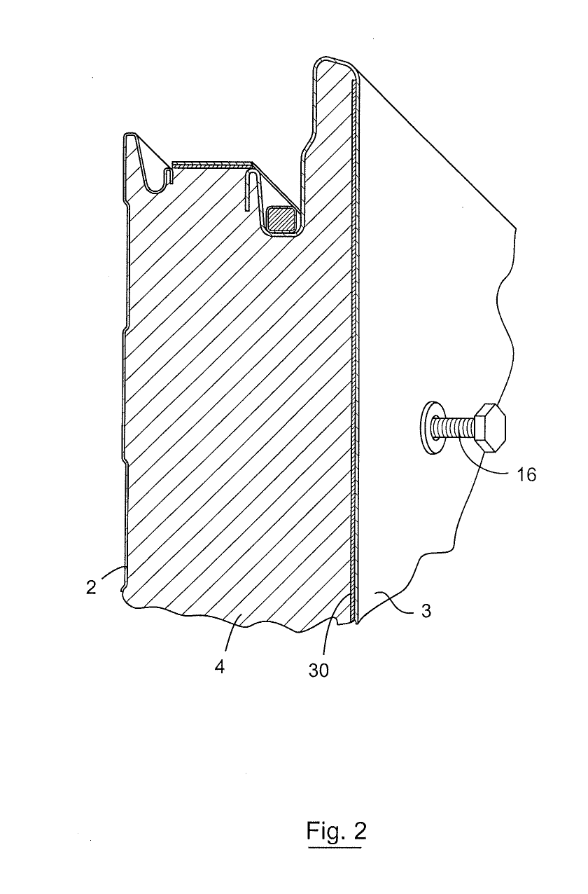

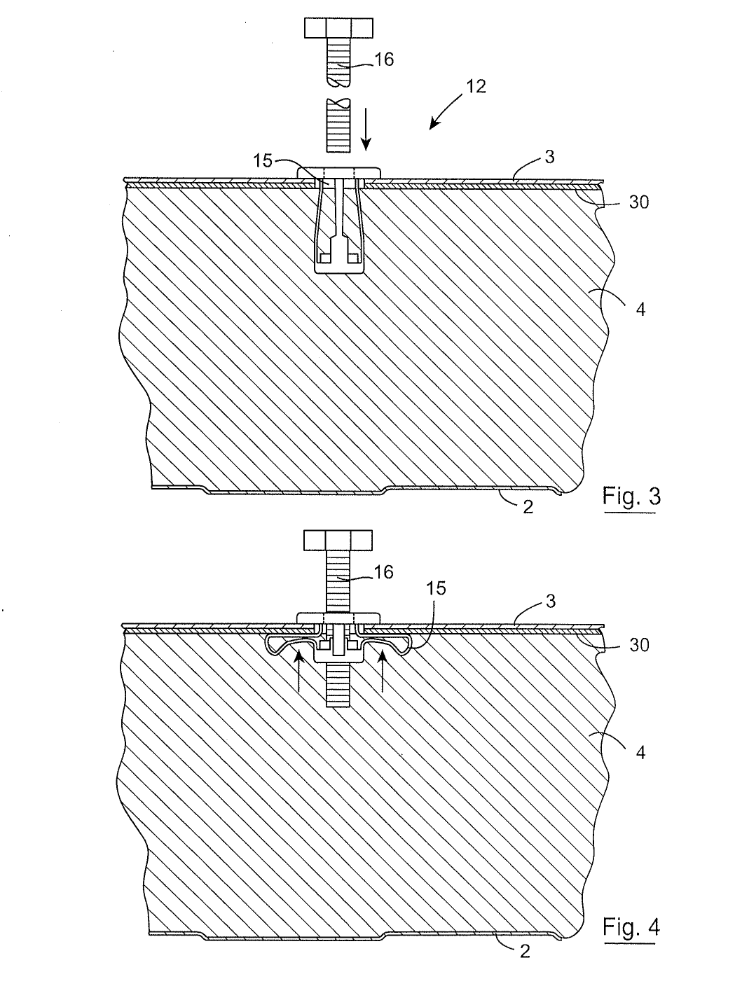

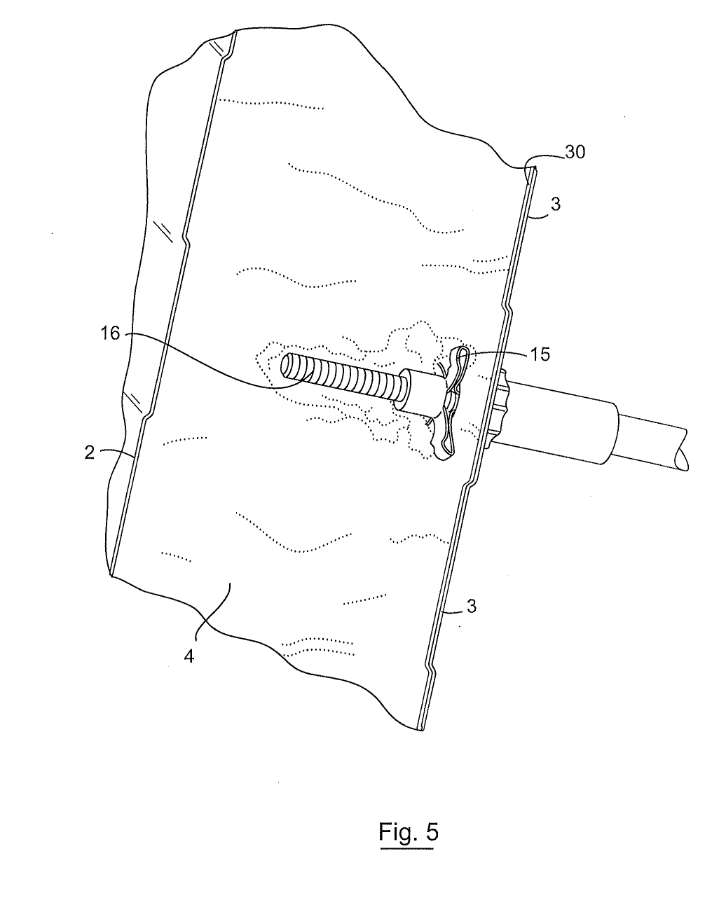

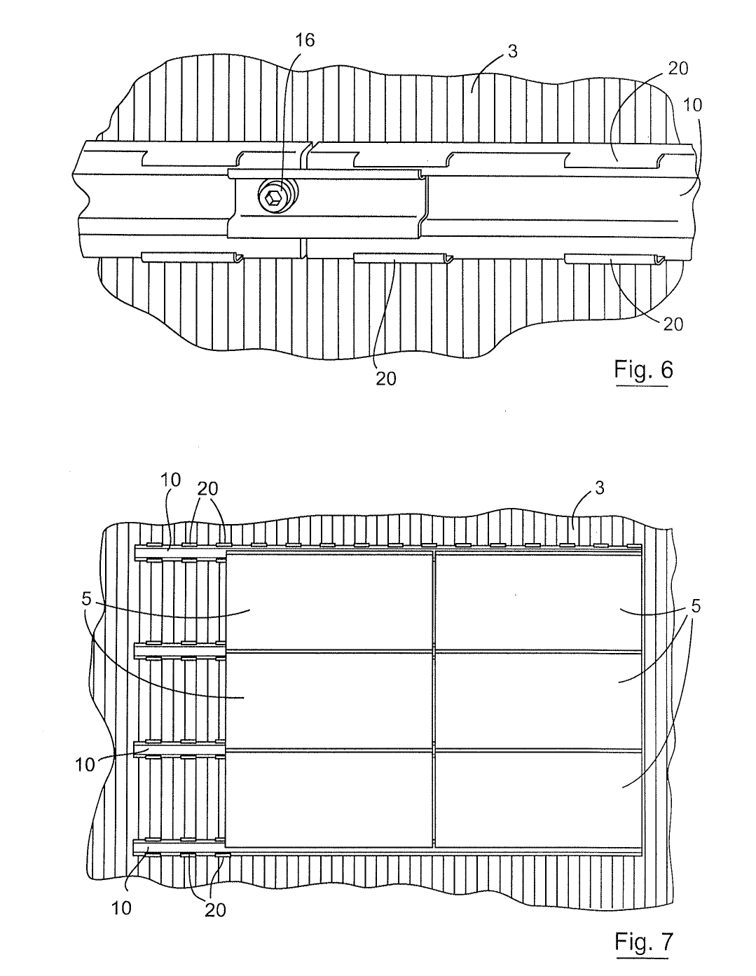

Each fastener 12 comprises an internal clamping sleeve 15 and a bolt 16. One such fastening systems is that referred to in a Fablok (Trade Mark). A hole is first drilled through the skin 3 and the sleeve 15 is inserted as illustrated in FIG. 3. On tightening of the bolt 16, the sleeve 15 splays and is clamped against the inside surface of the external skin 3 as will be particularly apparent for FIGS. 4 and 5. The rail 10 has pre-drilled holes through which the shanks of the bolts 16 are inserted. On tightening of the bolts 16, the rails 10 are fixed to the panels. In this way the rails 10 are efficiently and effectively clamped to the external skin 3. The rails 10 are omitted from FIGS. 2 to 5 for clarity.

The rails 10 and associated tiles 5 may be of the type available from Agrob Buchtal of Germany. The rails 10 have formations 20 which inter-engage with corresponding formations 21 on the tiles 5 for ease of assembly of the tiles 5 to the rails 10 without a requirement for fixing screws and the like.

To enhance the peel strength of the composite panel a layer 30 of an adhesive is applied to the internal face of the external skin 3. The adhesive layer 30 is a pre-lay-down adhesive which is compatible with the material of the insulting core 4. We have found that the use of such an adhesive greatly enhances the peel strength of the panel and enables the panel to carry the additional load of the cladding tiles.

In manufacture, an external skin 3 is drawn from a reel and laid down in a lay-down bed with the internal face uppermost. The adhesive 30 is then uniformly applied over the internal face of the skin 3 prior to lay-down of liquid foam reactants. The inner skin 2 is then led from a reel and located above the liquid foam reactants.

The assembly is the passed through an oven in which the liquid foam reactants expand to form the insulating core 4. A desired length of panel is then cut. The rails 10 are laid out across the external face of the skin 3 and the locations for fastening the receiving holes to be drilled in the panel are marked. The rails may be removed, the holes drilled and the clamping sleeves 15 inserted. The holes in the rails 10 are aligned with the clamping sleeves 15 and the bolts are inserted and tightened, clamping the rails 10 to the skin 3 as described above. The tiles 5 are then fixed to the rails 10 using the clipping system provided by the spaced-apart formations 20 on the rails and the corresponding formations 21 of the tiles 5. The tiles are clicked into place and held on the brackets/rails 10. No fixing screws or the like are required to mount the tiles 5 on the rails 10.

The invention provides a composite panel of relatively simple but highly robust construction which facilitates easy on site cladding with finishing tiles such as brick tiles.

The invention is not limited to the embodiments hereinbefore described which may be varied in detail.

1-20. (canceled)

21. A composite cladding panel comprising:
an internal skin having an inner surface and an outer surface;
an external skin having an inner surface and an outer surface:
an insulating foam core between the inner surface of the internal skin and the inner surface of the external skin;
a layer of adhesive between the inner face of the external skin and the insulation;
a plurality of spaced-apart rails for fixing tiles or the like to the panel to form a cladding;
the rails being mounted to the outer surface of the external skin; and
a plurality of fasteners for fastening the rail to the panel;
wherein the adhesive acts to prevent delamination of the inner face of the external skin and the insulation.

22. The panel as claimed in claim 21, wherein the fasteners comprise clamping fasteners.

23. The panel as claimed in claim 21, wherein the fasteners comprise clamping fasteners; and wherein each clamping fastener comprises an internal sleeve and a bolt, the sleeve splaying on tightening of the bolt to the inner surface of the external skin.

24. The panel as claimed in claim 21, wherein the rails comprise receivers for receiving cladding elements such as bricks.

25. The panel as claimed in claim 21, wherein the adhesive comprises a pre-laydown adhesive.

26. A composite cladding panel comprising:
an internal steel skin,
an external steel skin having an internal face,
foam insulation material between the internal skin and the external skin, and
a plurality of mountings for fixing tiles or the like to the panel to form a cladding, the mountings comprising a plurality of fasteners and rails supported by the fasteners,
wherein the external skin is substantially planar, and a layer of adhesive is applied to the internal face of the external skin, and being compatible with the insulating material.

27. The composite cladding panel as claimed in claim 26, wherein:
the fasteners are clamping fastener, and
said clamping fasteners each comprise a bolt and an internal clamping sleeve, said sleeve being annular and being splayed out and clamped against the adhesive layer and the external skin, and extending inwardly into the insulation.

28. A method for manufacturing a composite cladding panel comprising the steps of:
manufacturing a composite insulating panel comprising an internal skin, an external skin with insulation material therebetween by laying the external skin down with the outer side lowermost,
applying an adhesive to the inner face of the external skin,
applying liquid foam reactants over the adhesive, applying an internal skin over the liquid foam reactants and heating the sandwich thus formed in an oven to form the composite insulating panel;
aligning mounting rails along at least portion of the external face of a skin; and
fastening the rails to the skin;
wherein the adhesive acts to prevent delamination of the inner face of the external skin and the insulation.

29. The method as claimed in claim 28, comprising the steps of drilling holes in the skin, inserting internal sleeves into the holes, and tightening bolts in the sleeves to splay the sleeve and clamp to the inner surface of the skin.

30. The method as claimed in claim 28, comprising the steps of drilling holes in the skin, inserting internal sleeves into the holes, and tightening bolts in the sleeves to splay the sleeve and clamp to the inner surface of the skin, and comprising the step of fixing the rail to the panel using the bolts.
